(19) United States
(12) Patent Application Publication
(10) Pub. No.: US 2002/0110779 A1
(43) Pub. Date: Aug. 15, 2002

(54) Dental mold and articulator for use in aligning dental models

(76) Inventor: Jose E. Walter, Centerville, VA (US)

Correspondence Address: Hendricks and Associates, P. O. Box 2509, Fairfax, VA, 22031-2509, US

(21) Appl. No.: 10/073,214

(22) Filed: Feb. 13, 2002

Related U.S. Application Data
(60) Provisional application No. 60/268,020, filed on Feb. 13, 2001.

(51) Int. Cl. A61C 11/00

(52) U.S. Cl. 433/60; 433/64

(57) ABSTRACT

The instant invention provides articulators and molds for use in such a system. The molds for making the models are made in such a manner that the resulting models have recesses for accepting attachment means from an articulator system. The reciprocating hinge means of the articulators attached to the stone bearing the models are then connected through interacting hinge means. A curved arm travels in a channel to allow adjustment of alignment. The arm has, at each end, a part of a hinge means for interaction with a reciprocating hinge portion on an arm attached to the model of the opposing jaw/tooth model.

This application takes priority from Provisional Application 60/268,020, filed Feb. 13, 2001.

### FIELD OF THE INVENTION

This invention relates to apparatus used in making dental models for use in production of bridges, crowns, and other restorative articles.

### BACKGROUND OF THE INVENTION

The production of restorative objects such as crowns, bridges and tooth prostheses requires use of dental models from which to work. The production of such models are first created using a negative impression of the teeth. The negative impression is then filled with casting materials which harden, thus creating models of the patient's teeth. In order to work with these models, the casting material must be sawed into smaller pieces. It is essential to be able to realign the pieces in the appropriate manner. The appropriate alignment of the models is accomplished by use of an articulator which allows movement between the models. While some of the prior art articulators allow only lateral movement between the models, it is preferable that the hinge means allow both lateral and horizontal movement between the models to simulate movements of the jaws.

The prior art includes several devices for use in making the models. U.S. Pat. No. 4,398,884 to Huffman, describes an insert which locks onto the casting material to guide removal of model teeth during insertion into and withdrawal from the dental model presents an approach to the need to divide, then reassemble the models. However, the devices disclosed therein do not provide means for relating the maxillary and mandibular dental arches with one another in such a way as to create an accurate three-dimensional model showing the arches as they were at the time the impression was made.

Another apparatus for creating dental models is disclosed in U.S. Pat. No. 4,708,835, to Kiefer, which shows a base plate containing a plurality of pre-formed holes is fitted with dowel pins in each location where it is desired to make a die removable from a cast dental arch. Two methods of determining which of the pre-formed holes in a base plate are to have dowel pins inserted in them are disclosed. One version requires the use of a transparent datum plate which is positioned over the base plate and fitted with marker pins at desired locations. The data plate is then removed from the carrier plate, flipped over and remounted on the opposite side of the upright of the carrier plate. The base plate is then mounted on the upright of the carrier plate, over the data plate, and dowel pins are inserted into preformed holes in the base plate at those positions occupied by marker pins in the underlying data plate. Both datum plate and base plate with dowel pins inserted are then removed from the carrier plate, and the base plate is again flipped over and remounted to the opposite side of the carrier plate upright over a dental impression containing freshly poured liquid die stone, and pushed downward so the base plate contacts the impression.

Whelan, in U.S. Pat. No. 4,439,151, describes a method to facilitate the mounting and dismounting of individual teeth by use of a central plastic insert member having projecting elements through the base of the tray to facilitate removal by pushing on said projection portions. The devise also includes a means to pivot the trays apart to 180 degrees to provide pouring of both tray and impressions. A shortcoming of this device is that a model of only the mandibular or maxillary arch can be made.

U.S. Pat. No. 5,769,634 to Choi teaches a tray modeling system and an articulator which is attached to dental casts which have been created in the trays. The articulator formed therein is much more complex and expensive to make than the instant invention. It is cumbersome and requires a complex spline release mechanism.

U.S. Pat. No. 5,800,166 to Huffman teaches an articulator for use in registration of a pair of casts of dental models. The mechanism is quite expensive and does not provide the flexibility at the joint mechanism to allow relational positioning of the models.

U.S. Pat. No. 5,957,688 to Van Valey teaches a dental model articulator wherein the articulator attachment is glued to the models, which is an awkward process. Furthermore, the hinge means are quite complex and, therefore, more expensive to make than the instantly claimed invention.

### BRIEF DESCRIPTION OF THE FIGURES

FIG. 1 is a view of a mold used to form a dental model.

FIG. 2 shows a mold for use in forming a dental model of teeth in only one side of the jaw.

FIG. 3 shows an articulator for use with a model prepared in the mold of FIG. 1

FIG. 4 shows a curved arm connecting a ball and a reciprocating portion of a hinge means for accepting a ball.

FIG. 5 shows a completed interacting hinge means which allows interaction between the mandibular and maxillary models.

FIG. 6 shows a posterior view of ball and socket hinge means as they interconnect.

FIG. 7 shows the means for insertion into the model and the channel through which the arm holding the ball at one end and a ball acceptor means at the other passes.

FIGS. 8 and 9 show means having screws for use in holding the arm bearing the hinge means in place.

### SUMMARY OF THE INVENTION

It is the purpose of this invention to provide articulator means which may be attached to dental casts to permit alignment of said casts in such a manner that the models of the teeth in the maxillary and mandibulary models can be adjusted to resemble the actual alignment of the teeth of the patient. The articulator of the invention allows translational motions between the models with true sliding interaction between the models. The invention provides identical articulator parts which interact through a hinge means, each part having an insertion portion for insertion into a recess in stone bearing a model of teeth and a channel through which passes a curved arm having at one end a first part of a hinge means and at the other end a second part of a hinge means for interaction with a hinge means from another arm bearing hinge means, said channel being adjustable in size to provide for ready movement of said arm through said channel and means for securing said arm in said channel by interaction of said securing means with said arm. The securing means may also be a latch means having reciprocating parts wherein the reciprocating parts of said latch means interact to constrict the channel.

### DETAILED DESCRIPTION OF THE INVENTION

When restoration work is required in dentistry, an impression is made of the teeth of the patient. After the impression has solidified, a negative dental impression may be filled with a casting material. The model of the teeth is made by filling the impression with a material (called “stone”) that will harden to form a model of the teeth. These models may be made on trays attached to an articulator such as that seen in U.S. Pat. No. 5,466,152 to Walter, which discloses and claims a dental articulator system wherein a tray is attached to a hinge means. The tray is filled with stone and the two halves of the articulator (the trays, wherein the two halves are made to interact by hinge means) are manipulated on said hinge means.

It is also possible to make models using trays or molds (often made of rubber or flexible plastic) filled with unhardened stone. The unhardened stone is pressed against the impression taken by the dentist to make a model of the teeth. The malleable material solidifies to a stone-like quality. The stone with models of the upper and lower teeth are then attached to an articulator which allows the laboratory technician to align the upper and lower models to show the bite at the time the impression was made. The instant invention provides articulators and molds for use in such a system. The molds for making the models are made in such a manner that the resulting models have recesses for accepting attachment means from an articulator system. While many attachment means designs might be used to attach the articulators to the stone bearing the tooth models, including screws or complex splines, the preferred attachment members are a shaped opening in the stone base of the models which will accept a compressible insert. The reciprocating hinge means of the articulators attached to the stone bearing the models are then connected through interacting hinge means. One curved arm has, at each end, a part of a hinge means for interaction with a reciprocating hinge portion on an arm attached to the model of the opposing jaw/tooth model. The arms bearing at each end one half of a hinge means move in channels. The size of the channels can be adjusted to either allow the arm to move within the channel while adjusting the bite of the models or to restrict the movement of the arm bearing two parts of a hinge means to set the bite of the models. The bite of the models can be readjusted repeatedly by releasing restraint on the arm and, after adjustment, again restricting the movement of the arm.

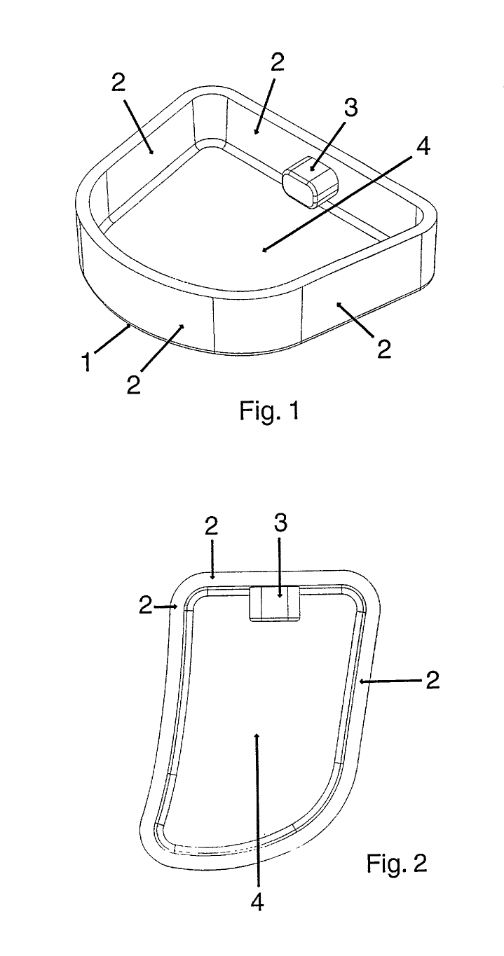

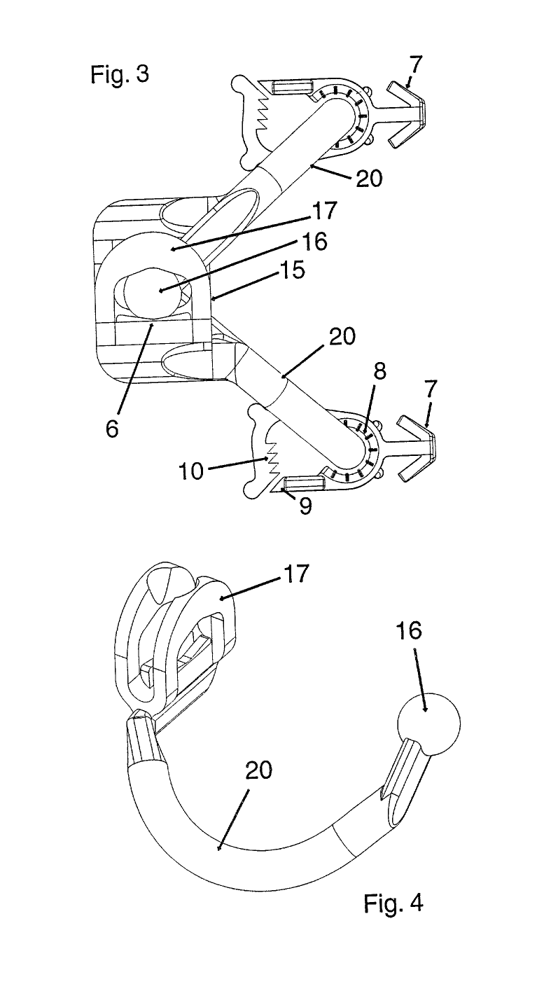

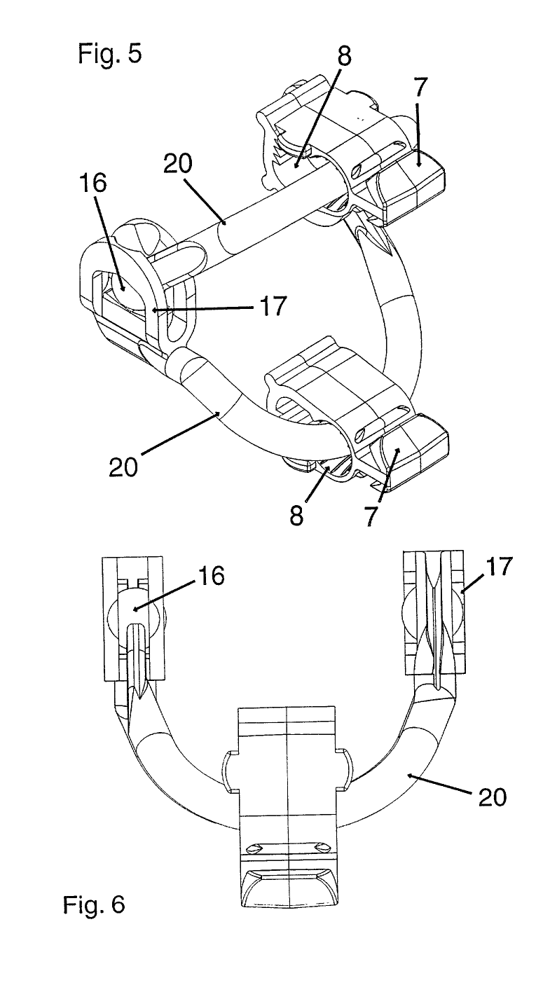

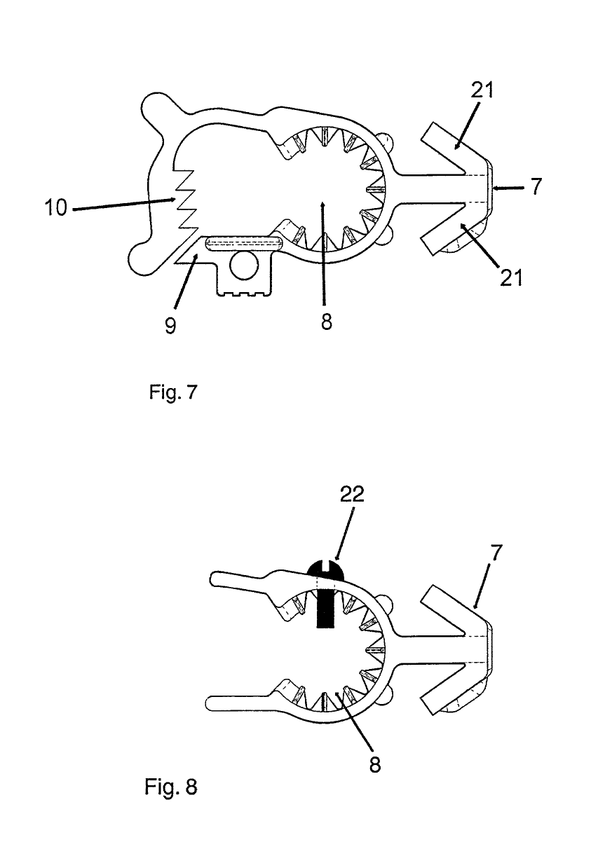

Referring to the drawings, FIG. 1 shows a mold (1) having sides (2), which define an interior space (4) with a protrusion (3) from the wall into the interior of the mold. When the stone bearing the model of the teeth is cast in the mold, the protrusion into the interior of the mold forms a recess in the stone. The recess is formed to accept an insert from the articulator. FIG. 2 shows a mold for forming a dental model of teeth of only one side of the jaw having sides (2) which define an interior space (4) and a protrusion into the interior space of the mold. FIG. 3 shows an articulator (6) having an insertion means (7) which fits into a recess in the stone with the model of the teeth, said recess resulting from the protrusion into the mold's interior space. Attached to the insertion means is a channel (8) which has channel size adjustment means (9) and (10) interact to adjust the size of the channel wherein the adjustment means is comprised of reciprocating parts of said adjustment means which interact to constrict the channel. The hinge means (15) consists of a ball (16) and ball acceptor (17). The ball and ball receptor means are attached to curved arms (20), each of which bear, at one end, a ball and, at the other, a ball receptor means. FIG. 4 shows the arm (20) with the ball portion of the hinge means (16) at one end and the ball receptor means (17) at the other end. FIG. 5 shows another perspective view of the articulator with the ball and ball receptor (17) portions interacting to form a completed hinge means attached to the arms (20), the portions which pass through the channels attached to insert into the stone (7), with the ball of the hinge portion (6) held in the receptor (17). FIG. 6 shows a posterior view of the ball portion of a hinge (16) and the receptor (17) holding the ball. FIG. 7 shows a cross sectional view of the channel (8) and the portion which inserts into the stone having “ears” (21) which are semiflexible and which, after insertion into the stone, hold the articulator in place in the stone model. The channel adjustment means (9) and (10) comprised of a latch means having reciprocating parts wherein the reciprocating parts of said latch means interact to constrict the channel, thus holding the arm bearing the hinge portions securely in a desired position.

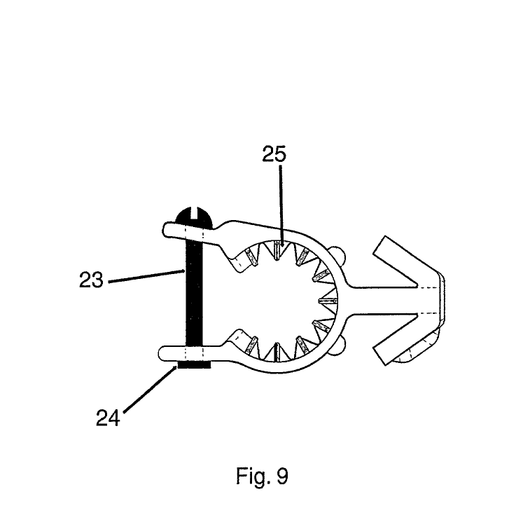

FIG. 8 shows a cross section of the channel (8) and insertion portion (7) of the articulator with screw (22) means which holds the arm in a fixed position. FIG. 9 shows the same cross sectional view with a bolt (23) and nut (24) used to adjust the size of the channel. The portion of the channel which contacts the arm is, preferably, made of a material that is sufficiently rigid and strong to hold the arm firmly and restrict movement of the arm. The entire channel may be made of such rigid material or there may be a more rigid material used for an interior ring (25) of the channel. For example, a separable ring (25) of metal may be inserted into the channel of a plastic articulator to provide necessary rigidity to hold the arm firmly after the channel size adjustment means has been manipulated to restrict movement.

Any means which will either narrow the channel or will interact with the arm in such a way as to hold it in place can be used as means to secure the arm bearing the hinge portions in place. Release of the arms to move freely in the channels makes it possible to align the models, while restricting movement of the arms allows study of the models to evaluate bite of the patient.

It is understood that any of the materials used in making dental laboratory equipment for making teeth may be used to make the articulator, though the most common materials will probably be plastic, metal or a combination of the two.

What we claim is:

1. An articulator having 2 identical parts which are attached through hinge means, each part having an insertion portion for insertion into a recess in stone bearing a model of teeth and a channel through which passes a curved arm having at a one end a first part of a hinge means and at the other end a second part of a hinge means for interaction with a hinge means from another identical part having an identical arm bearing hinge means, said channel being adjustable in size to provide for ready movement of said arm through said channel, said channel being subject to securing means for securing said arm in said channel.

2. The articulator of claim 1 wherein the securing means is a screw.

3. The articulator of claim 1 wherein the securing means is a bolt.

4. The articulator of claim 1 wherein the securing means is comprised of a latch means having reciprocating parts wherein the reciprocating parts of said latch means interact to constrict the channel.
